(19) United States
(12) Patent Application Publication
(10) Pub. No.: US 2024/0261898 A1
(43) Pub. Date: Aug. 8, 2024

(54) LASER PROCESSING DEVICE AND LASER PROCESSING METHOD

(71) Applicant: KOMATSU INDUSTRIES CORPORATION, Kanazawa-shi, Ishikawa (JP)

(72) Inventors: Yoshihiro YAMAGUCHI, Kanazawa-shi, Ishikawa (JP); Nobuhiro TAKATA, Kanazawa-shi, Ishikawa (JP); Shigeru NOZAKI, Kanazawa-shi, Ishikawa (JP)

(73) Assignee: KOMATSU INDUSTRIES CORPORATION, Kanazawa-shi, Ishikawa (JP)

(21) Appl. No.: 18/564,708

(22) PCT Filed: Apr. 28, 2022
(86) PCT No.: PCT/JP2022/019321

§ 371 Date: Nov. 28, 2023

(30) Foreign Application Priority Data
Jun. 17, 2021 (JP) 2021-100988

(51) Int. Cl. B23K 26/14

(52) U.S. Cl. CPC B23K 26/1435

(57) ABSTRACT

A container can store a transmission inhibition liquid that inhibits transmission of a laser beam. A liquid storage unit has an internal space, and is connected to the container such that the transmission inhibition liquid stored in the container enters the internal space. A transmittance detection sensor detects transmittance of the internal space in the liquid storage unit.

### TECHNICAL FIELD

The present disclosure relates to a laser processing device and a laser processing method.

### BACKGROUND ART

Examples of the laser processing device using a fiber laser include a machine room-type fiber laser processing device and a gantry-type fiber laser processing device. A machine room-type fiber laser processing device is used when a workpiece is relatively small. In this type of processing device, an entire cutting table is covered with a machine room such that a laser beam does not leak to an outside of the device.

The gantry-type fiber laser processing device is used when the workpiece is relatively large. In this type of processing device, because the entire cutting table cannot be covered, a periphery of a laser head is covered with a cover such that the laser beam does not leak to the outside of the device.

For example, the gantry-type fiber laser processing device is disclosed in Japanese Patent No. 5940582 (PTL 1). In PTL 1, a light shielding member is attached to a lower end side of each of a laser nozzle-side cover body and a garter-side cover body. The light shielding member prevents the leakage of the laser beam from a gap between a lower end of each of the laser nozzle-side cover body and the garter-side cover body and an upper surface of a surface plate.

For example, a device using water in the laser processing device is disclosed in Japanese Patent Laying-Open No. 8-132270 (PTL 2) and Japanese Patent Laying-Open No. 62-168692 (PTL 3).

In PTL 2, the laser processing is performed in a state where a lower portion of the workpiece is immersed in cooling water in a water tank of a machining table. Thus, the entire workpiece can be cooled from below, and stable processing can be performed.

In PTL 3, the workpiece supported by a sword pin is subjected to the laser processing while water is put in a mounting box of the sword pin. The water in the water tank cools the workpiece during laser cutting to prevent scattering of dust.

### CITATION LIST

### Patent Literatures

PTL 1: Japanese Patent No. 5940582
PTL 2: Japanese Patent Laying-Open No. 8-132270
PTL 3: Japanese Patent Laying-Open No. 62-168692

### SUMMARY OF INVENTION

### Technical Problem

In the laser processing device described in PTL 1, there is a risk that the laser beam penetrates the workpiece to leak to the outside of the device by being reflected in the cutting table below the workpiece. In order to prevent the leakage of the laser beam, a cutting table-side light shielding member is required to be installed below the workpiece. For this reason, a structure of the laser processing device becomes complicated.

Furthermore, in PTL 1, the cutting table-side light shielding member disposed below the workpiece is scraped off little by little by the laser beam. For this reason, light shielding becomes not perfect as time elapses, and the laser beam leaks to the outside of the device.

Furthermore, in PTLs 2 and 3, the water in the water tank is used for the purpose of cooling the workpiece or preventing the scattering of the dust, and the light shielding of the laser beam is not considered.

An object of the present disclosure is to provide a laser processing device and a laser processing method capable of preventing the leakage of the laser beam to the outside with a simple device configuration.

### Solution to Problem

A laser processing device of the present disclosure is a laser processing device processing a workpiece using a laser beam, the laser processing device including a container, a liquid storage unit, and a transmittance detection sensor. The container can store a transmission inhibition liquid inhibiting transmission of the laser beam. The liquid storage unit is disposed outside the container, has an internal space, and is connected to the container such that the transmission inhibition liquid stored in the container enters the internal space. The transmittance detection sensor detects at least the transmittance of the internal space.

A laser processing method of the present disclosure is a laser processing method for processing a workpiece placed on a placement unit in a container using a laser beam, the laser processing method including the following steps.

A transmission inhibition liquid inhibiting transmission of the laser beam is stored in the container. At least the transmittance of an internal space in the liquid storage unit that is disposed outside the container, is connected to the container at a position lower than the placement unit, and has the internal space that the transmission inhibition liquid stored in the container enters is detected. A laser beam emission operation is controlled based on the detected transmittance.

### Advantageous Effects of Invention

According to the present disclosure, the laser processing device and the laser processing method capable of preventing the leakage of the laser beam to the outside can be implemented with the simple device configuration.

### BRIEF DESCRIPTION OF DRAWINGS

FIG. 1 is a perspective view illustrating a configuration of a laser processing device according to an embodiment.

FIG. 2 is a sectional perspective view illustrating an internal configuration of a container used in the laser processing device of FIG. 1.

FIG. 3 is a perspective view illustrating an example of a configuration of a transmittance detection sensor and a liquid storage unit in FIG. 2.

FIG. 4 is a perspective view illustrating a modification of the configuration of the transmittance detection sensor and the liquid storage unit in FIG. 2.

FIG. 5 is a sectional view illustrating a configuration of a laser head used in the laser processing device in FIG. 1.

FIG. 6 is a sectional view illustrating a configuration of a laser beam shielding member used in the laser processing device in FIG. 1.

FIG. 7 is a sectional view illustrating a configuration of a liquid level adjustment mechanism used in the laser processing device in FIG. 1.

FIG. 8 is a flowchart illustrating a laser processing method of the embodiment.

FIG. 9 is a sectional perspective view illustrating how a workpiece is subjected to laser processing.

### DESCRIPTION OF EMBODIMENT

With reference to the drawings, an embodiment of the present disclosure will be described in detail below. In the specification and the drawings, the same components or corresponding components are denoted by the same reference numerals, and redundant description will not be repeated. In the drawings, the construction may be omitted or simplified for convenience of description. In addition, at least a part of the embodiment and a modification may be arbitrarily combined with each other.

### <Construction of Laser Processing Device>

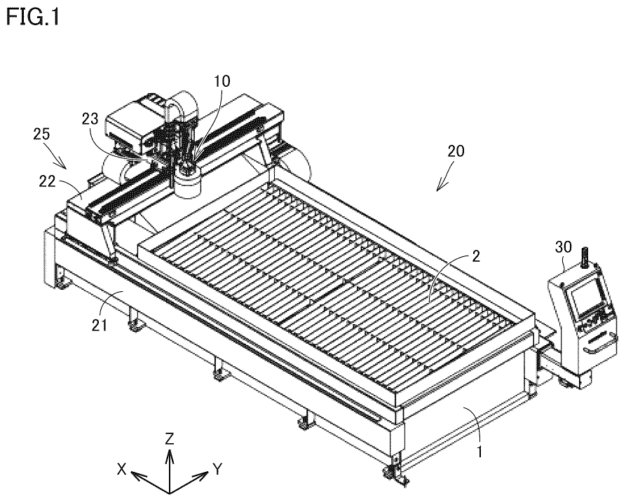

With reference to FIGS. 1 to 7, a configuration of a laser processing device of the embodiment will be described below.

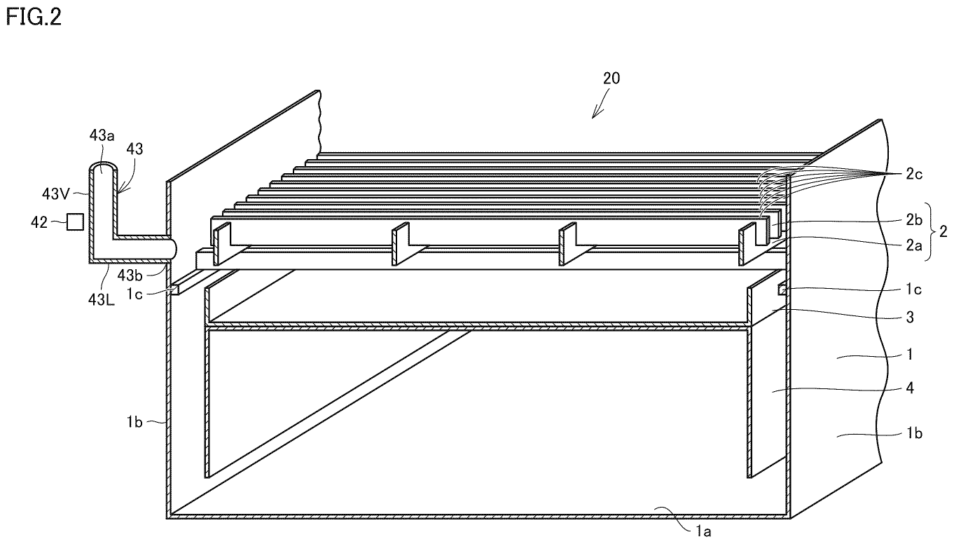

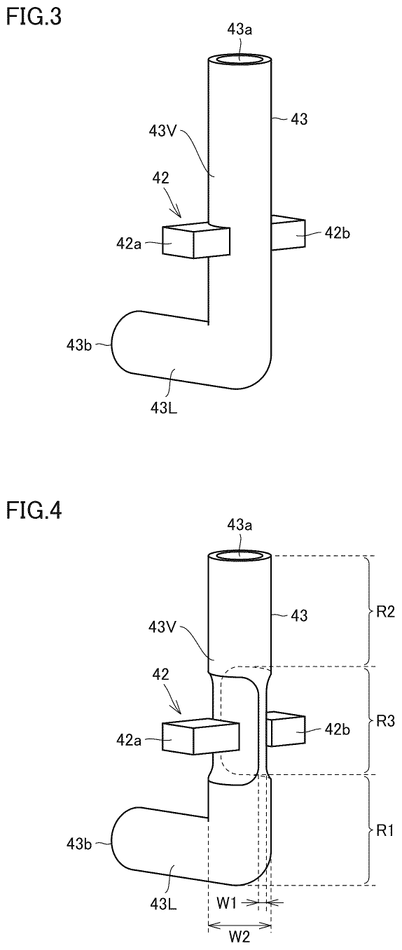

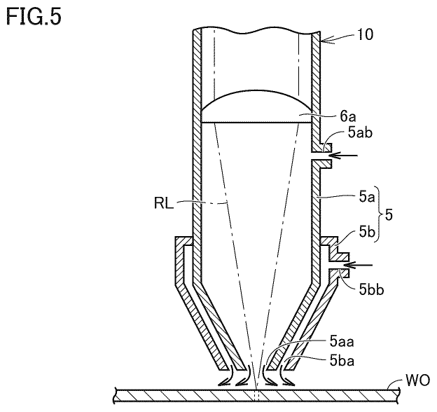

FIG. 1 is a perspective view illustrating the construction of the laser processing device of the embodiment. FIG. 2 is a sectional perspective view illustrating an internal construction of a container used in the laser processing device of FIG. 1. FIGS. 3 and 4 are perspective views illustrating an example and a modification of the configuration of a transmittance detection sensor and a liquid storage unit in FIG. 2. FIGS. 5, 6, and 7 are sectional views illustrating configurations of a laser head, a laser beam shielding member, and a liquid level adjustment mechanism used in the laser processing device of FIG. 1.

As illustrated in FIGS. 1 and 2, a laser processing device 20 of the embodiment mainly includes a container 1, a cutting pallet 2 (support member), a sludge tray 3, a liquid level adjustment tank 4, a laser head 10, a drive mechanism 25, and an operation panel 30.

As illustrated in FIG. 2, container 1 includes a rectangular bottom wall 1a and four side walls 1b rising from each of four sides of bottom wall 1a. Container 1 has a bottomed cylindrical shape with an open top. Container 1 includes an opening at an upper end and an internal space extending from the opening to an inside of container 1.

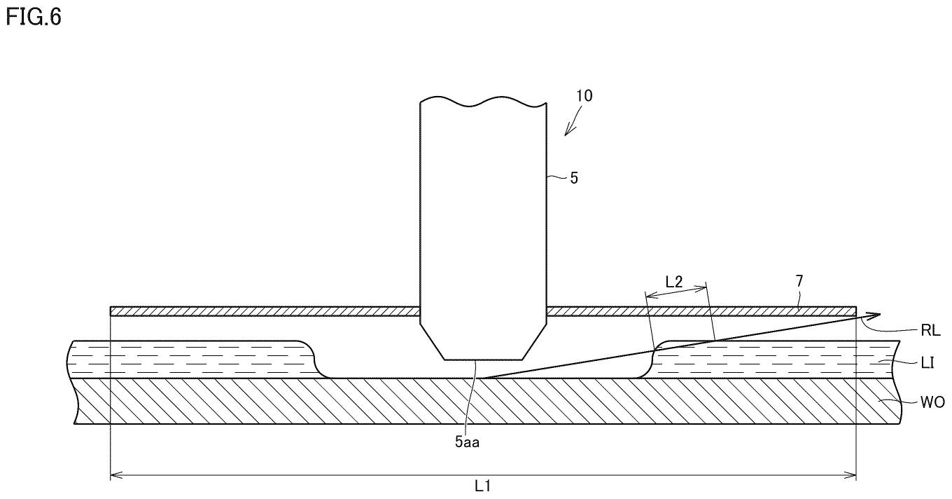

Container 1 is configured to be able to store a liquid (transmission inhibition liquid LI: FIG. 6) therein. A pallet support 1c is provided in side wall 1b. Pallet support 1c protrudes laterally from a wall surface of side wall 1b toward the internal space of container 1.

Liquid level adjustment tank 4 is disposed in the internal space of container 1. Liquid level adjustment tank 4 has a box shape including an opening at a lower end. Through this opening, the internal space of liquid level adjustment tank 4 is connected to the internal space of container 1.

Liquid level adjustment tank 4 is constructed to be able to store gas in the internal space of liquid level adjustment tank 4. The gas can be supplied to or discharged from the internal space of liquid level adjustment tank 4. Transmission inhibition liquid LI in liquid level adjustment tank 4 can be pushed out of liquid level adjustment tank 4 by supplying the gas into the internal space of liquid level adjustment tank 4. Transmission inhibition liquid LI can be taken in from the outside to the inside of liquid level adjustment tank 4 by discharging the gas from the internal space of liquid level adjustment tank 4. Thus, the liquid level in container 1 can be adjusted.

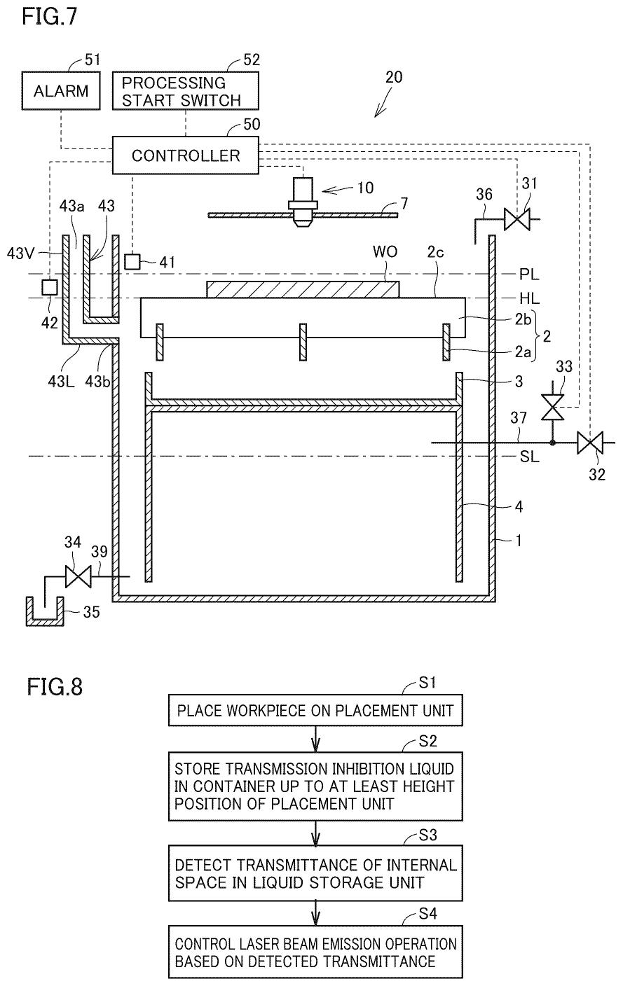

Sludge tray 3 is disposed above liquid level adjustment tank 4. Sludge tray 3 has a box shape including the opening at the upper end. Sludge tray 3 can accumulate sludge generated when the workpiece is cut by the laser processing. The sludge generated during the laser processing falls from a workpiece WO (FIG. 7) and is accumulated inside sludge tray 3 through the opening at the upper end of sludge tray 3.

Cutting pallet 2 is supported by container 1 using pallet support 1c. Cutting pallet 2 is disposed in the interior space of container 1 and above sludge tray 3. Cutting pallet 2 includes a plurality of first support plates 2a and a plurality of second support plates 2b. The plurality of first support plates 2a and the plurality of second support plates 2b are assembled in a lattice shape by being arranged vertically and horizontally.

Cutting pallet 2 includes a placement unit 2c that supports a lower surface of workpiece WO (FIG. 7). For example, placement unit 2c of cutting pallet 2 is constructed by an upper end of each of the plurality of second support plates 2b. Placement unit 2c is located at a position lower than the upper end of container 1 (the upper end of side wall 1b). The upper end of container 1 is located at a position higher than the upper surface of workpiece WO while workpiece WO is placed on placement unit 2c. Thus, when container 1 is filled with transmission inhibition liquid LI while workpiece WO is placed on placement unit 2c, a liquid level of transmission inhibition liquid LI can be made higher than the upper surface of workpiece WO.

The laser processing device 20 of the embodiment includes a transmittance detection sensor 42 and a liquid storage unit 43. Liquid storage unit 43 is disposed outside container 1. Liquid storage unit 43 has a tubular shape and includes an internal space 43a. Liquid storage unit 43 is connected to side wall 1b of container 1 at a connection unit 43b.

For example, liquid storage unit 43 includes a laterally extension unit 43L and a longitudinally extension unit 43V. For example, liquid storage unit 43 has an L-shape by connecting a lower end of longitudinally extension unit 43V to one end of laterally extension unit 43L. Liquid storage unit 43 is connected to side wall 1b of container 1 at the other end of laterally extension unit 43L. An upper end of longitudinally extension unit 43V may be opened to the outside. Thus, internal space 43a of liquid storage unit 43 is connected to the outside of liquid storage unit 43.

Internal space 43a of liquid storage unit 43 is connected to the internal space of container 1. Thus, when transmission inhibition liquid LI is stored at a liquid level higher than or equal to connection unit 43b in the internal space of container 1, transmission inhibition liquid LI enters internal space 43a of liquid storage unit 43.

A part or a whole of liquid storage unit 43 includes a transparent portion. Liquid storage unit 43 is configured such that a portion that transmission inhibition liquid LI enters is the transparent portion. The transparent portion of liquid storage unit 43 is preferably transparent to a wavelength of a laser beam used for processing workpiece WO. For example, the transparent portion of liquid storage unit 43 is made of a glass tube. A part or the whole of longitudinally extension unit 43V in liquid storage unit 43 is the transparent portion, and may be made of the glass tube.

Connection unit 43b between liquid storage unit 43 and container 1 is located below a height position of placement unit 2c. Liquid storage unit 43 extends upward from connection unit 43b above the height position of placement unit 2c. Specifically, longitudinally extension unit 43V of liquid storage unit 43 extends from a position lower than the height position of placement unit 2c to a position higher than the height position of placement unit 2c. When workpiece WO is placed on placement unit 2c, longitudinally extension unit 43V preferably extends to a position higher than the height position of the upper surface of workpiece WO.

Transmittance detection sensor 42 detects at least transmittance of internal space 43a in liquid storage unit 43. For example, transmittance detection sensor 42 detects the transmittance of internal space 43a in longitudinally extension unit 43V. Transmittance detection sensor 42 detects the transmittance of internal space 43a in the transparent portion in liquid storage unit 43. Transmittance detection sensor 42 detects the transmittance of internal space 43a in the portion of liquid storage unit 43 located below the height position of placement unit 2c.

In a state where transmission inhibition liquid LI is contained in liquid storage unit 43, transmittance detection sensor 42 can detect the transmittance during the transmission through both transmission inhibition liquid LI and liquid storage unit 43. In a state where transmission inhibition liquid LI is not contained in liquid storage unit 43, transmittance detection sensor 42 can detect the transmittance during the transmission through both air in internal space 43a and liquid storage unit 43.

Accordingly, transmittance detection sensor 42 can also detect the transmittance of liquid storage unit 43 itself by taking a difference between the transmittance in the state where transmission inhibition liquid LI is in liquid storage unit 43 and the transmittance in the state where air is in liquid storage unit 43. Thus, a contamination degree or the like of liquid storage unit 43 can be known by detecting the transmittance with transmittance detection sensor 42.

As illustrated in FIG. 3, for example, transmittance detection sensor 42 is a transmission type laser discrimination sensor. For example, transmittance detection sensor 42 includes a light emission unit 42a and a light reception unit 42b. Light emission unit 42a and the light reception unit 42b sandwich liquid storage unit 43. Specifically, light emission unit 42a and light reception unit 42b laterally sandwich longitudinally extension unit 43V of liquid storage unit 43.

Detection light emitted from light emission unit 42a is received by light reception unit 42b after passing through internal space 43a of longitudinally extension unit 43V. Thus, the transmittance of internal space 43a in liquid storage unit 43 is measured. For example, the detection light emitted from light emission unit 42a is a laser beam. The detection light is preferably the laser beam having the same wavelength as the laser beam emitted from laser head 10.

Transmittance detection sensor 42 may include light emission unit 42a and reflection unit 42b. Light emission unit 42a and reflection unit 42b sandwich liquid storage unit 43. Specifically, light emission unit 42a and reflection unit 42b laterally sandwich longitudinally extension unit 43V of liquid storage unit 43.

The detection light emitted from light emission unit 42a is reflected by reflection unit 42b after passing through internal space 43a of longitudinally extension unit 43V. The detection light reflected by reflection unit 42b may be received by light emission unit 42a after passing through internal space 43a of longitudinally extension unit 43V again. In this case, light emission unit 42a also has a function as the light reception unit. Detection light reflected by reflection unit 42b may be received by a light reception unit (not illustrated) separate from light emission unit 42a.

Longitudinally extension unit 43V maintains the same dimension in the entire height direction.

As illustrated in FIG. 4, longitudinally extension unit 43V of liquid storage unit 43 may have a constricted portion (thin portion) R3 in a part in the height direction. Specifically, longitudinally extension unit 43V may have a constricted shape in which second portion R3 is thinner than first portions R1, R2.

Longitudinally extension unit 43V of liquid storage unit 43 has first portions R1, R2 and second portion R3. In longitudinally extension unit 43V of liquid storage unit 43, first portion R1, second portion R2, and first portion R3 are arranged in this order from the bottom. Each of first portions R1, R1 has a first dimension W1, and second portion R3 has a second dimension W2. Second dimension W2 is smaller than first dimension W1.

When longitudinally extension unit 43V of liquid storage unit 43 has the constricted shape, transmittance detection sensor 42 detects at least the transmittance of internal space 43a in second portion R3 (constricted unit). For this reason, when transmittance detection sensor 42 includes light emission unit 42a and light reception unit 42b, light emission unit 42a and light reception unit 42b sandwich second portion R3. In addition, when transmittance detection sensor 42 includes light emission unit 42a and reflection unit 42b, light emission unit 42a and reflection unit 42b sandwich second portion R3.

As illustrated in FIG. 1, drive mechanism 25 moves laser head 10 in the X-direction (longitudinal direction of container 1), the Y-direction (lateral direction of container 1), and the Z-direction (vertical direction). Drive mechanism 25 mainly includes a pair of left and right support bases 21, an X-direction movable base 22, a Y-direction movable base 23, and laser head 10.

The pair of left and right support bases 21 is disposed so as to sandwich container 1 in the Y-direction. The pair of left and right support bases 21 extends in the X-direction. X-direction movable base 22 is disposed across the pair of left and right support bases 21 by extending in the Y-direction. X-direction movable base 22 is driven in the X-direction along the support base 21 by an X-axis motor (not illustrated).

Y-direction movable base 23 is supported to be movable in the Y-direction with respect to X-direction movable base 22 by, for example, a rack and pinion mechanism. Y-direction movable base 23 is driven in the Y-direction by a Y-axis motor (not illustrated).

Laser head 10 is supported to be movable in the Z-direction with respect to Y-direction movable base 23 by, for example, a rack and pinion mechanism. Laser head 10 is driven in the Z-direction by a Z-axis motor (not illustrated).

Operation panel 30 receives input of a processing condition such as a plate thickness, a material, and a speed of workpiece WO. Operation panel 30 includes a display, a switch, and an alarm. The display displays an input screen of the machining condition, a screen indicating an operating status of laser processing device 20, and the like.

As illustrated in FIG. 5, laser head 10 mainly includes a head body 5 and a condensing lens 6a. Head body 5 includes a body 5a.

Body 5a has a hollow cylindrical shape. Condensing lens 6a is accommodated in body 5a. Condensing lens 6a condenses a laser beam RL on workpiece WO. Laser beam RL condensed by condensing lens 6a is emitted from a laser emission port 5aa (emission unit) of body 5a toward workpiece WO.

Laser beam RL used in laser processing device 20 of the embodiment has any wavelength of visible light, near-infrared light, mid-infrared light, and far-infrared light, and has a wavelength greater than or equal to 0.7 μm and less than or equal to 10 μm. For example, laser beam RL is a laser beam using fiber laser as a light source, and may be a laser beam using solid-state laser containing Yttrium Aluminum Garnet (YAG) as a light source. The fiber laser is a type of solid-state laser using an optical fiber as an amplification medium. In the fiber laser, a core located at the center of the optical fiber is doped with rare earth element Yb (ytterbium). Laser beam RL using the fiber laser as a light source is near-infrared light having a wavelength of about 1.06 μm. Running cost and maintenance cost of the fiber laser are lower than those of a carbon dioxide laser.

Body 5a includes a gas outlet 5aa and a gas supply unit 5ab. An assist gas is supplied from gas supply unit 5ab into body 5a. The assist gas supplied into body 5a is blown out from gas outlet 5aa toward workpiece WO. Gas outlet 5aa also serves as a laser emission port 5aa.

Head body 5 may further include an outer nozzle 5b. Outer nozzle 5b is attached to body 5a so as to surround the periphery of gas outlet 5aa of body 5a. A gap space is provided between the inner peripheral surface of outer nozzle 5b and the outer peripheral surface of body 5a.

Outer nozzle 5b includes a gas outlet 5ba and a gas supply unit 5bb. Each of gas outlet 5ba and gas supply unit 5bb is connected to the gap space. Gas outlet 5ba is disposed on an outer periphery of gas outlet 5aa, and has an annular shape.

The secondary gas (shielding gas) is supplied from gas supply unit 5bb to the gap space between body 5a and outer nozzle 5b. The secondary gas supplied into the gap space is blown out from gas outlet 5ba toward workpiece WO. Thus, the secondary gas is blown out from gas outlet 5ba onto the outer peripheral side of the assist gas blown out from gas outlet 5aa.

As described above, laser head 10 has gas outlets 5aa, 5ba. Gas outlets 5aa, 5ba may include gas outlet 5aa through which the assist gas is blown out and gas outlet 5ba through which the secondary gas is blown out. Gas outlet 5aa and gas outlet 5ba form a double nozzle structure.

As illustrated in FIG. 6, laser head 10 includes a laser beam shielding member 7. Laser beam shielding member 7 surrounds the periphery of laser head 10. For example, laser beam shielding member 7 is made of a metal plate having rigidity. For example, laser beam shielding member 7 is a plate member 7. For example, plate member 7 has an annular shape. Plate member 7 is attached to head body 5 by a fixing member (not illustrated) such as a bolt. Plate member 7 extends from the position where plate member 7 is attached to head body 5 about gas outlet 5aa in planar view onto the outer peripheral side. Thus, plate member 7 surrounds the periphery of laser emission port 5aa of laser head 10.

For example, plate member 7 may be made of a carbon plate. The lower surface (the surface opposite to workpiece WO) of plate member 7 may be black so as to easily absorb the laser beam. A reflector may be attached to the lower surface of plate member 7. Alternatively, a carbon sheet or a rubber sheet may be attached to the lower surface of metal plate member 7.

Plate member 7 absorbs or reflects the laser beam emitted from laser emission port 5aa of head body 5 and reflected by workpiece WO. The laser beam is absorbed by plate member 7, whereby intensity of laser beam is reduced. In addition, the laser beam is reflected by plate member 7 and passes through transmission inhibition liquid LI, whereby the intensity of the laser beam is reduced. Thus, the leakage of the laser beam is prevented from between plate member 7 and workpiece WO.

Furthermore, as indicated by an arrow RL in the drawing, there is the laser beam that does not hit plate member 7 but leaks to the outside from the gap between plate member 7 and workpiece WO. A dimension (diameter L1) of plate member 7 is set such that the laser beam passes through transmission inhibition liquid LI by a predetermined distance L2. When the laser beam passes through transmission inhibition liquid LI by predetermined distance L2, the intensity of the laser beam is sufficiently reduced. Thus, the leakage of the laser beam is prevented from between plate member 7 and workpiece WO.

As illustrated in FIG. 7, a supply pipe 36 is provided in order to supply transmission inhibition liquid LI (FIG. 6) into container 1. A supply valve 31 is attached to supply pipe 36. The supply of transmission inhibition liquid LI to the internal space of container 1 is started by opening supply valve 31, and the supply of transmission inhibition liquid LI to the internal space of container 1 is stopped by closing supply valve 31.

A gas pipe 37 is connected to the liquid level adjustment tank 4 from the outside of container 1. A pressurizing valve 32 and a pressure reducing valve 33 are attached to gas pipe 37. The gas is supplied into liquid level adjustment tank 4 when pressurizing valve 32 is opened, and the supply of the gas into liquid level adjustment tank 4 is stopped when the pressurizing valve 32 is closed. The gas in liquid level adjustment tank 4 is discharged to the outside by opening pressure reducing valve 33, and the discharge of the gas from liquid level adjustment tank 4 is stopped by closing pressure reducing valve 33. Liquid level adjustment tank 4, gas pipe 37, pressurizing valve 32, and pressure reducing valve 33 are included in the liquid level adjustment mechanism. As described later, the liquid level adjustment mechanism adjusts the liquid level of a transmission inhibition liquid LI in container 1 based on the detection result of a liquid level detection sensor 41.

An overflow pipe (not illustrated) is attached to container 1. When the liquid level of transmission inhibition liquid LI in container 1 becomes higher than or equal to a predetermined liquid level, transmission inhibition liquid LI in container 1 is discharged to a liquid storage tank 35 through the overflow pipe. Liquid storage tank 35 is disposed outside container 1.

A liquid discharge pipe 39 is attached to container 1. A discharge valve 34 is attached to liquid discharge pipe 39. Transmission inhibition liquid LI in container 1 is discharged to liquid storage tank 35 by opening discharge valve 34, and the discharge of transmission inhibition liquid LI from container 1 is stopped by closing discharge valve 34.

Container 1 is configured to be capable of storing transmission inhibition liquid LI at least up to a height position HL of placement unit 2c. Container 1 is capable of storing transmission inhibition liquid LI up to a position PL higher than the upper surface of workpiece WO placed on placement unit 2c.

Transmission inhibition liquid LI stored in container 1 inhibits transmission of the laser beam. For example, transmission inhibition liquid LI inhibits the transmission of the light having a wavelength greater than or equal to 0.7 μm and less than or equal to 10 μm.

For example, the transmittance of the light in a wavelength range greater than or equal to 0.7 μm and less than or equal to 10 μm in transmission inhibition liquid LI is less than or equal to 10%/cm. For example, the transmittance of the light in the wavelength range greater than or equal to 0.7 μm and less than or equal to 10 μm in transmission inhibition liquid LI is preferably less than or equal to 5%/cm. For example, the transmittance of the light in the wavelength range greater than or equal to 0.7 μm and less than or equal to 10 μm in transmission inhibition liquid LI is more preferably less than or equal to 3%/cm.

Transmission inhibition liquid LI contains an additive that absorbs or scatters the light in the wavelength range greater than or equal to 0.7 μm and less than or equal to 10 μm in order to inhibit the transmission of the light in the wavelength range greater than or equal to 0.7 μm and less than or equal to 10 μm. For example, this additive contains carbon. The additive is preferably black. For example, transmission inhibition liquid LI is an aqueous solution obtained by adding carbon to water. For example, transmission inhibition liquid LI is an aqueous solution obtained by adding 0.1 vol % of India ink to water. The water in the present specification may be tap water or pure water. The India ink is obtained by dispersing carbon black (carbon) in an aqueous solution of glue or another water-soluble resin, and a mixing ratio of the carbon black is 4.0 wt % to 20.0 wt %, preferably 5.0 wt % to 10.0 wt % with respect to the total amount. For example, the India ink is commercially available “Kuretake concentrated ink Bokuteki BA7-18”.

Transmission inhibition liquid LI preferably contains a rust inhibitor. The rust inhibitor is a corrosion inhibitor that inhibits corrosion of a steel material or the like. For example, the rust inhibitor is water-soluble. For example, a precipitated film type inhibitor, a passive type inhibitor, or a deoxygenated type inhibitor may be used as the rust inhibitor.

Laser processing device 20 further includes a liquid level detection sensor 41, a controller 50, an alarm 51, and a processing start switch 52. Liquid level detection sensor 41 is installed in container 1 and has a function of detecting the liquid level of transmission inhibition liquid LI stored in container 1. For example, liquid level detection sensor 41 is a guide pulse type level sensor.

Transmittance detection sensor 42 detects the transmittance in internal space 43a of liquid storage unit 43. When transmission inhibition liquid LI is contained in internal space 43a of liquid storage unit 43, transmittance detection sensor 42 detects the transmittance of transmission inhibition liquid LI. Concentration of an additive (for example, carbon) contained in transmission inhibition liquid LI can be known by detecting the transmittance of transmission inhibition liquid LI using transmittance detection sensor 42.

Alarm 51 gives a notification of the state of laser processing device 20 to the outside by display, sound, or the like. Alarm 51 may be a warning light, a display, or a speaker provided on operation panel 30 (FIG. 1). Processing start switch 52 issues an instruction to start the laser processing by laser processing device 20 by an external operation. Processing start switch 52 may be provided on operation panel 30. Processing start switch 52 may be a touch panel provided on operation panel 30.

Controller 50 controls to open and close supply valve 31, pressurizing valve 32, pressure reducing valve 33, and discharge valve 34. Although a line connecting controller 50 and discharge valve 34 is not illustrated in FIG. 7, this is for simplification of the drawing. Controller 50 controls movement of laser head 10 in the X-, Y-, and Z-directions, laser irradiation from laser head 10, and the like. Controller 50 controls the notification of alarm 51.

Controller 50 receives a signal indicating the liquid level of transmission inhibition liquid LI in container 1 detected by liquid level detection sensor 41. Controller 50 receives a signal indicating the transmittance of internal space 43a in liquid storage unit 43 detected by transmittance detection sensor 42. Controller 50 receives a signal indicating a processing start instruction by processing start switch 52.

Controller 50 controls opening and closing of pressurizing valve 32 or pressure reducing valve 33 based on the detection result of liquid level detection sensor 41. Thus, an amount of gas stored in liquid level adjustment tank 4 is adjusted, and the liquid level of transmission inhibition liquid LI stored in container 1 is adjusted. In this manner, controller 50 controls the opening and closing of pressurizing valve 32 or pressure reducing valve 33 such that the liquid level adjustment mechanism (liquid level adjustment tank 4, gas pipe 37, pressurizing valve 32, and pressure reducing valve 33) adjusts the liquid level of transmission inhibition liquid LI stored in container 1.

Controller 50 issues a control instruction for at least one of the notification by alarm 51 and a laser beam emission operation based on the detection result of transmittance detection sensor 42. When the transmittance of transmission inhibition liquid LI detected by transmittance detection sensor 42 is greater than a predetermined value (for example, 10%/cm, 5%/cm, or 3%/cm), controller 50 issues the control instruction to execute the notification by alarm 51 or the control instruction to stop execution of the laser beam emission operation (or not to start the laser beam emission operation). For example, the notification by alarm 51 is performed by display or sound.

On the other hand, when the transmittance of transmission inhibition liquid LI detected by transmittance detection sensor 42 is less than or equal to the predetermined value (for example, 10%/cm, 5%/cm, or 3%/cm), controller 50 issues the control instruction to start the laser beam emission operation. At this point, controller 50 may control alarm 51 to notify the execution of the laser beam emission operation, or control alarm 51 not to execute the notification.

For example, controller 50 is a processor, and may be a central processing unit (CPU).

### <Laser Processing Method>

With reference to FIGS. 7 to 9, a laser processing method using the laser processing device of the embodiment will be described below.

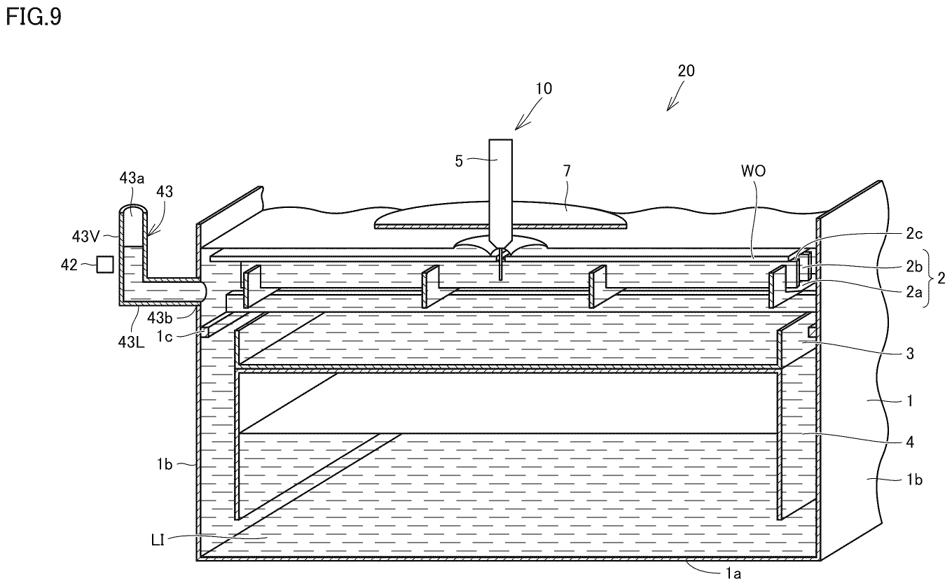

FIG. 8 is a flowchart illustrating the laser processing method of the embodiment. FIG. 9 is a view illustrating a state in which the workpiece is subjected to the laser processing.

As illustrated in FIG. 7, transmission inhibition liquid LI is supplied into container 1 of laser processing device 20. At this point, controller 50 controls to open supply valve 31. Thus, transmission inhibition liquid LI is supplied from supply pipe 36 into container 1. At this point, controller 50 detects the liquid level of transmission inhibition liquid LI in container 1 using liquid level detection sensor 41. When determining that the liquid level of transmission inhibition liquid LI in container 1 reaches a desired liquid level SL based on the detection result of liquid level detection sensor 41, controller 50 controls supply valve 31 to be closed. At this point, for example, transmission inhibition liquid LI is supplied to a position SL lower than height position HL of placement unit 2c of cutting pallet 2.

Workpiece WO is carried into laser processing device 20. Workpiece WO is disposed on placement unit 2c of cutting pallet 2 (step S1: FIG. 8). For example, workpiece WO is a steel material. In this state, the laser processing operation by laser processing device 20 is started.

For example, the laser processing operation in laser processing device 20 is started by operating processing start switch 52. When the laser processing operation is started, controller 50 adjusts the liquid level of transmission inhibition liquid LI stored in container 1 to a standby liquid level based on the detection result of liquid level detection sensor 41. Specifically, for example, controller 50 controls pressurizing valve 32 to open. Thus, the gas is supplied into liquid level adjustment tank 4, and the liquid level of transmission inhibition liquid LI stored in container 1 is adjusted to be high to the standby liquid level.

Thereafter, the upper surface height of workpiece WO is detected, and a target liquid level PL of transmission inhibition liquid LI is determined based on the upper surface height of workpiece WO. Target liquid level PL is set at height position HL of placement unit 2c or above height position HL. In the embodiment, for example, target liquid level PL is set at a position higher than the upper surface of workpiece WO.

When target liquid level PL is determined, the liquid level of transmission inhibition liquid LI is adjusted to at least height position HL of placement unit 2c as target liquid level PL by adjusting the liquid level of transmission inhibition liquid LI (step S2: FIG. 8). In the embodiment, for example, the liquid level of transmission inhibition liquid LI is adjusted to position PL higher than the upper surface of workpiece WO. Thus, as illustrated in FIG. 9, entire workpiece WO sinks (is immersed) in transmission inhibition liquid LI.

Transmission inhibition liquid LI also enters internal space 43a of liquid storage unit 43, and the liquid level of transmission inhibition liquid LI in internal space 43a also becomes liquid level PL. In this state, controller 50 controls transmittance detection sensor 42 to detect the transmittance of internal space 43a in liquid storage unit 43 (step S3: FIG. 8).

At this point, in the state where transmission inhibition liquid LI is contained up to the detection height position by transmittance detection sensor 42, transmittance detection sensor 42 can detect the transmittance when both transmission inhibition liquid LI and liquid storage unit 43 are transmitted. In addition, in the state where transmission inhibition liquid LI is not contained up to the detection height position by transmittance detection sensor 42, transmittance detection sensor 42 can detect the transmittance when both the air in internal space 43a and liquid storage unit 43 are transmitted.

Controller 50 controls the laser beam emission operation based on the transmittance detected by transmittance detection sensor 42 (step S4: FIG. 8). The reason is as follows.

Controller 50 determines whether the transmittance detected by transmittance detection sensor 42 changes with respect to the transmittance before the liquid level rises. The transmittance before the liquid level rise is the transmittance detected in the state where transmission inhibition liquid LI does not enter internal space 43a in the portion detected by transmittance detection sensor 42. For example, the transmittance before the liquid level rise is the transmittance of internal space 43a when the liquid level of transmission inhibition liquid LI is liquid level SL lower than the height position of placement unit 2c.

When it is determined that the transmittance detected by transmittance detection sensor 42 does not change from the transmittance before the liquid level rise as described above, controller 50 determines that the liquid level of transmission inhibition liquid LI does not rise to the liquid level at the height position detected by transmittance detection sensor 42. In this case, controller 50 controls laser processing device 20 not to start the laser beam emission operation or to stop the laser beam emission operation. In this case, controller 50 controls alarm 51 to notify by display or sound that the liquid level of transmission inhibition liquid LI does not rise to the liquid level at the height position detected by transmittance detection sensor 42.

When determining that the transmittance detected by transmittance detection sensor 42 changes with respect to the transmittance before the liquid level rise, controller 50 determines that the liquid level of transmission inhibition liquid LI rises to at least the liquid level at the height position detected by transmittance detection sensor 42.

In this case, controller 50 determines whether the transmittance of transmission inhibition liquid LI detected by transmittance detection sensor 42 is less than or equal to predetermined transmittance. In order to correct the influence of contamination or the like of the liquid storage unit 43, the transmittance of transmission inhibition liquid LI may be calculated from a value of a difference between the transmittance before the liquid level rises and the transmittance after the liquid level rises. The predetermined transmittance is a transmittance that can prevent the laser beam emitted to workpiece WO from leaking out of laser processing device 20. For example, the predetermined transmittance is 10%/cm, 5%/cm, or 3%/cm.

When the transmittance of transmission inhibition liquid LI is greater than the predetermined transmittance, controller 50 controls laser processing device 20 not to start the laser beam emission operation or to stop the performance of the laser beam emission operation. When the transmittance of transmission inhibition liquid LI is greater than the predetermined transmittance, controller 50 controls alarm 51 to notify that the transmittance of transmission inhibition liquid LI is greater than the predetermined transmittance by the display or the sound.

On the other hand, when the transmittance of transmission inhibition liquid LI is less than or equal to the predetermined transmittance, controller 50 controls laser processing device 20 so as to start the laser beam emission operation by laser processing device 20 or not to stop the laser beam emission operation. The laser beam emission operation described above includes an operation moving laser head 10 to a processing start position and an operation emitting the laser beam from laser head 10 to workpiece WO as described below.

When it is determined that the transmittance of transmission inhibition liquid LI is less than or equal to the predetermined transmittance, laser head 10 moves to the processing start position. The movement of laser head 10 is controlled by controller 50. Specifically, laser head 10 descends in the Z-direction toward workpiece WO to the height position of the processing start position.

Thereafter, as illustrated in FIG. 9, the laser processing by laser processing device 20 is started. During the laser processing, workpiece WO is irradiated with the laser beam from laser head 10. Furthermore, the assist gas is blown from laser head 10 toward workpiece WO.

Transmission inhibition liquid LI is pushed away at a processing point of workpiece WO by blowing force of the assist gas. Thus, the upper surface of workpiece WO is exposed from transmission inhibition liquid LI at the processing point of workpiece WO.

The upper surface of workpiece WO exposed from transmission inhibition liquid LI is irradiated with the laser beam. Workpiece WO is processed by the irradiation with the laser beam. Thus, for example, workpiece WO is cut. The laser beam that penetrates workpiece WO by cutting workpiece WO enters transmission inhibition liquid LI stored below workpiece WO.

The assist gas blown out from laser head 10 is discharged to the outside from between the lower surface of laser beam shielding member 7 and the liquid surface of transmission inhibition liquid LI. Because of this, pressure of the gas is prevented from increasing between the lower surface of laser beam shielding member 7 and the liquid level of transmission inhibition liquid LI due to the blowing of the assist gas.

Sludge generated when workpiece WO is cut by the laser processing sinks into transmission inhibition liquid LI and accumulates in sludge tray 3. For example, the sludge is iron oxide particles in which molten iron is hardened. As described above, the laser processing is performed while workpiece WO is immersed in transmission inhibition liquid LI, whereby scattering of the sludge generated during the processing to the surroundings is prevented.

As illustrated in FIG. 7, when the laser processing is completed, controller 50 controls laser head 10 to move to an initial position. Specifically, X-direction movable base 22 illustrated in FIG. 1 moves in the X-direction with respect to the pair of left and right support bases 21. Y-direction movable base 23 moves in the Y-direction with respect to X-direction movable base 22. Laser head 10 moves in the Z-direction with respect to Y-direction movable base 23.

As illustrated in FIG. 7, after laser head 10 moves to the initial position, the liquid level of transmission inhibition liquid LI is adjusted to the position lower than the lower surface of workpiece WO by adjusting the liquid level of transmission inhibition liquid LI. Thus, entire workpiece WO is exposed from transmission inhibition liquid LI.

Specifically, for example, controller 50 controls pressure reducing valve 33 to open after the detection of the end of the laser processing. Thus, the amount of gas stored in liquid level adjustment tank 4 is reduced, and transmission inhibition liquid LI flows into liquid level adjustment tank 4. Therefore, the liquid level of transmission inhibition liquid LI in container 1 is lowered. At this point, controller 50 detects the liquid level of transmission inhibition liquid LI in container 1 using liquid level detection sensor 41. When determining that the liquid level of transmission inhibition liquid LI in container 1 reaches the desired liquid level SL, controller 50 controls pressure reducing valve 33 to be closed.

After the liquid level of transmission inhibition liquid LI in container 1 reaches the predetermined liquid level SL, workpiece WO is carried out of laser processing device 20. As needed, cutting pallet 2 and sludge tray 3 are taken out of container 1. After that, the sludge in sludge tray 3 is removed.

As described above, the laser processing using laser processing device 20 of the embodiment is performed. Although the method for cutting workpiece WO has been described above as the laser processing method, the laser processing method may be a processing method such as welding using the laser beam.

### Advantageous Effect of Embodiment

An advantageous effect of the embodiment will be described below.

In the embodiment, as illustrated in FIG. 7, container 1 can store transmission inhibition liquid LI. For this reason, the laser beam processing workpiece WO enters transmission inhibition liquid LI after penetrating workpiece WO. Transmission inhibition liquid LI inhibits the transmission of the laser beam. Thus, the transmission of the laser beam entering transmission inhibition liquid LI is inhibited by transmission inhibition liquid LI. Accordingly, the intensity of the laser beam is reduced in transmission inhibition liquid LI, and the leakage of the laser beam to the outside of laser processing device 20 is prevented.

In addition, the leakage of the laser beam to the outside of laser processing device 20 is prevented only by storing transmission inhibition liquid LI in container 1. Thus, the light shielding member preventing the leakage of the laser beam is not required to be installed below workpiece WO. Accordingly, the leakage of the laser beam to the outside of laser processing device 20 is prevented with a simple structure.

In addition, the leakage of the laser beam is prevented without covering entire container 1 with a machine room like the machine room-type fiber laser processing device.

Transmission inhibition liquid LI may inhibit the transmission of the light having the wavelength greater than or equal to 0.7 μm and less than or equal to 10 μm. In this case, when the laser beam having the wavelength greater than or equal to 0.7 μm and less than or equal to 10 μm is used as the laser beam, the transmission of the laser beam incident into transmission inhibition liquid LI is inhibited by transmission inhibition liquid LI. Accordingly, the intensity of the laser beam is reduced in transmission inhibition liquid LI, and the leakage of the laser beam to the outside of laser processing device 20 is prevented.

In addition, using the fiber laser as the laser beam source, power consumption in the laser processing is reduced and a life is lengthened. The light of the fiber laser easily transmits water or the like as compared with the light of the carbon dioxide laser (wavelength of 10.6 μm). However, in the embodiment, because transmission inhibition liquid LI inhibits the transmission of the light having the wavelength greater than or equal to 0.7 μm and less than or equal to 10 μm as described above, even when the fiber laser is used as the laser beam source, the laser beam is prevented from leaking out of laser processing device 20.

In addition, transmittance detection sensor 42 that detects the transmittance of internal space 43a in liquid storage unit 43 is provided. Thus, the transmittance of transmission inhibition liquid LI is detected, and the laser beam does not leak to the outside of laser processing device 20 is checked, and then the laser processing can be performed.

In addition, the transmittance of liquid storage unit 43 itself can also be detected by transmittance detection sensor 42. When the transmittance is detected in the case where the liquid level of transmission inhibition liquid LI is low, the contamination of liquid storage unit 43 can also be detected, and cleaning and replacement of liquid storage unit 43 can be urged. In addition, when the intensity (emission power) of the detection light in transmittance detection sensor 42 decreases, the decrease in the intensity of the detection light can also be detected.

In the embodiment, as illustrated in FIG. 7, container 1 can store transmission inhibition liquid LI at least up to height position HL of placement unit 2c. Consequently, the laser beam after penetrating workpiece WO can be more reliably prevented from leaking out of laser processing device 20.

In the embodiment, as illustrated in FIG. 7, controller 50 issues the control instruction of at least one of the notification and the laser beam emission operation based on the detection result of transmittance detection sensor 42. Thus, when the transmittance of transmission inhibition liquid LI is greater than the predetermined transmittance, the start of the laser beam emission operation, the notification that the transmittance is large, and the like can be executed. When the transmittance of transmission inhibition liquid LI is less than or equal to the predetermined transmittance, the start of the laser beam emission operation or the like can be executed. Consequently, the leakage of the laser beam to the outside of laser processing device 20 during the laser processing can be reliably prevented.

In the embodiment, as illustrated in FIG. 3, liquid storage unit 43 includes the transparent portion that transmission inhibition liquid LI enters. Transmittance detection sensor 42 includes light emission unit 42a and light reception unit 42b that receives the light emitted from light emission unit 42a and transmitted through the transparent portion of liquid storage unit 43. Consequently, the transmittance of internal space 43a in liquid storage unit 43 can be detected by transmittance detection sensor 42.

In the embodiment, as illustrated in FIG. 3, liquid storage unit 43 includes the transparent portion that transmission inhibition liquid LI enters. Transmittance detection sensor 42 includes light emission unit 42a and reflection unit 42b that reflects the light emitted from light emission unit 42a and transmitted through the transparent portion of liquid storage unit 43. Consequently, the transmittance of internal space 43a in liquid storage unit 43 can be detected by transmittance detection sensor 42.

In the embodiment, as illustrated in FIG. 7, liquid storage unit 43 is connected to container 1 at connection unit 43b located below height position HL of placement unit 2c, and extends upward from connection unit 43b above height position HL of placement unit 2c. Thus, transmittance detection sensor 42 can detect whether transmission inhibition liquid LI is stored at least up to height position HL of placement unit 2c.

In the embodiment, as illustrated in FIG. 4, liquid storage unit 43 has first portions R1, R2 and second portion R3 thinner than first portions R1, R2. Transmittance detection sensor 42 detects the transmittance of the laser beam at second portion R3. Thus, even when transmission inhibition liquid LI having the low transmittance is contained in second portion R3, the detection light emitted from transmittance detection sensor 42 easily transmits through second portion R3. For this reason, the transmittance can be easily detected by transmittance detection sensor 42.

It should be considered that the disclosed embodiment is illustrative and non-restrictive in every respect. The scope of the present invention is defined by not the description above, but the claims, and it is intended that all modifications within the meaning and scope equivalent to the claims are included in the present invention.

### REFERENCE SIGNS LIST

1: container, 1a: bottom wall, 1b: side wall, 1c: pallet support, 2: cutting pallet, 2a: first support plate, 2b: second support plate, 2c: placement unit, 3: sludge tray, 4: liquid level adjustment tank, 5: head body, 5a: body, 5aa, 5ba: gas outlet, 5ab, 5bb: gas supply unit, 5b: outer nozzle, 6a: condensing lens, 7: laser beam shielding member, 10: laser head, 20: laser processing device, 21: support base, 22: X-direction movable base, 23: Y-direction movable base, 25: drive mechanism, 30: operation panel, 31: supply valve, 32: pressurizing valve, 33: pressure reducing valve, 34: discharge valve, 35: liquid storage tank, 36: supply pipe, 37: gas pipe, 39: liquid discharge piping, 41: liquid level detection sensor, 42: transmittance detection sensor, 42a: light emission unit, 42b: light reception unit or reflection unit, 43: liquid storage unit, 43L: laterally extension unit, 43V: longitudinally extension unit, 43a: internal space, 43b: connection unit, 50: controller, 51: alarm, 52: processing start switch, LI: transmission inhibition liquid, R1, R3: first portion, R2, R3: second portion, WO: workpiece

1: A laser processing device processing a workpiece using a laser beam, the laser processing device comprising:
a container that can store a transmission inhibition liquid inhibiting transmission of the laser beam;
a liquid storage unit that is disposed outside the container, has an internal space, and is connected to the container such that the transmission inhibition liquid stored in the container enters the internal space; and
a transmittance detection sensor that detects at least transmittance of the internal space.

2: The laser processing device according to claim 1, further comprising a support member that includes a placement unit supporting a lower surface of the workpiece,
wherein the container can store the transmission inhibition liquid at least up to a height position of the placement unit.

3: The laser processing device according to claim 1, further comprising a controller that issues a control instruction of at least one of notification and a laser beam emission operation based on a detection result of the transmittance detection sensor.

4: The laser processing device according to claim 1, wherein the liquid storage unit includes a transparent portion that the transmission inhibition liquid enters, and
the transmittance detection sensor includes a light emission unit and a light reception unit that receives light emitted from the light emission unit and transmitted through the transparent portion.

5: The laser processing device according to claim 1, wherein the liquid storage unit includes a transparent portion that the transmission inhibition liquid enters, and
the transmittance detection sensor includes a light emission unit and a reflection unit that reflects light emitted from the light emission unit and transmitted through the transparent portion.

6: The laser processing device according to claim 2, wherein the liquid storage unit is connected to the container at a connection unit located below the placement unit, and extends from the connection unit upward from the placement unit.

7: The laser processing device according to claim 1, wherein the liquid storage unit includes a first portion and a second portion thinner than the first portion, and
the transmittance detection sensor detects at least transmittance of the internal space at the second portion.

8: A laser processing method for processing a workpiece placed on a placement unit in a container using a laser beam, the laser processing method comprising:
storing a transmission inhibition liquid inhibiting transmission of the laser beam in the container;
detecting at least transmittance of an internal space in a liquid storage unit that is disposed outside the container, is connected to the container at a position lower than the placement unit, and has the internal space that the transmission inhibition liquid stored in the container enters; and
controlling a laser beam emission operation based on the detected transmittance.
